(19) United States
(12) Patent Application Publication
(10) Pub. No.: US 2002/0015530 A1
(43) Pub. Date: Feb. 7, 2002

(54) Method and device for alerting during progressive decoding of a digital image coded with a region of interest

(76) Inventors: Felix Henry, Rennes (FR); Maryline Charrier, Rennes (FR); Bertrand Berthelot, Rennes (FR)

Correspondence Address: FITZPATRICK CELLA HARPER & SCINTO, 30 ROCKEFELLER PLAZA, NEW YORK, NY, 10112, US

(21) Appl. No.: 09/910,927

(22) Filed: Jul. 24, 2001

(30) Foreign Application Priority Data
Jul. 25, 2000 (FR) 0009729

(51) Int. Cl. G06K 9/36; G06K 9/46

(52) U.S. Cl. 382/233

(57) ABSTRACT

The invention relates to a method for alerting during the progressive decoding of a digital image coded with a region of interest, characterised in that it includes the stages of:

detection (E13) of the end of the decoding of the said region of interest,

activation (E14) of an indication of the end of decoding of the said region of interest.

The present invention relates in a general way to the progressive decoding of digital data coded with at least one region of interest. These digital data are digital images. The invention relates more particularly to alerting during this progressive decoding.

The most recent methods for compressing images make it possible to code an image in a progressive way in terms of quality. The decoding of this image is also progressive, and it is possible to display a part of the image, or a low-quality version thereof, before the entire image has been decoded. In step with the decoding of the supplementary data, the quality of the image displayed is enhanced. This possibility is especially advantageous during the transmission of the coded image, since, upon reception, the operations of receiving, decoding and display are performed in a progressive way.

Moreover, it is possible to define a region of interest in the image. A region of interest is composed of one or more parts of the image. The region of interest is defined by a user and will be coded with a higher quality by comparison with the rest of the image.

The standard JPEG2000 (in the course of standardisation) allows the two functionalities to be implemented.

In this context, the present invention aims to supply an indication during the progressive decoding of an image coded with a region of interest, in such a way as to indicate to a user the end of the decoding of the region of interest.

To that end, the invention proposes a method for alerting during the progressive decoding of a digital image coded with a region of interest, characterised in that it includes the stages of:

detection of the end of the decoding of the said region of interest,

activation of an indication of the end of decoding of the said region of interest.

Correspondingly, the invention relates to a device for alerting during the progressive decoding of a digital image coded with a region of interest, characterised in that it includes:

means for detecting the end of the decoding of the said region of interest,

means for activating an indication of the end of decoding of the said region of interest.

By virtue of the invention, the user knows that the region of interest has been completely received; he can start his interpretation thereof, or interrupt the decoding if the rest of the image is not of interest to him.

According to one preferred characteristic, the method further includes the stages of:

activation of an indication of the start of decoding of the said region of interest,

activation of an indication of the progress of the decoding of the said region of interest.

Thus the user is in a position to follow the progress of the decoding of the region of interest.

According to another preferred characteristic, the method further includes the stage of decoding of the coded data of the image which are not in the said region of interest.

According to another preferred characteristic, the method further includes the stages of:

activation of an indication of decoding of the coded data of the image which are not in the said region of interest,

activation of an indication of the end of decoding of the coded data of the image which are not in the said region of interest.

Thus the user knows the progress of the decoding of the entire image.

According to one preferred characteristic, the indication is a display of information data on a screen.

Such information is simple to perceive for the user.

The alerting device includes means for implementing the preceding characteristics.

The invention also relates to a method and a device for receiving data incorporating the alerting method presented above.

The invention further relates to a method and a device for progressive decoding of a digital image coded with a region of interest, incorporating the alerting method presented above.

The invention also relates to a digital apparatus including the alerting, decoding or receiving device, or means for implementing the alerting, decoding or receiving method. The advantages of the device and of the digital apparatus are identical to those set out above.

An information storage means, which can be read by a computer or by a microprocessor, integrated into the device or otherwise, possibly removable, stores in memory a program implementing the alerting, receiving or decoding method.

The characteristics and advantages of the present invention will emerge more clearly on reading a preferred embodiment illustrated by the attached drawings, in which:

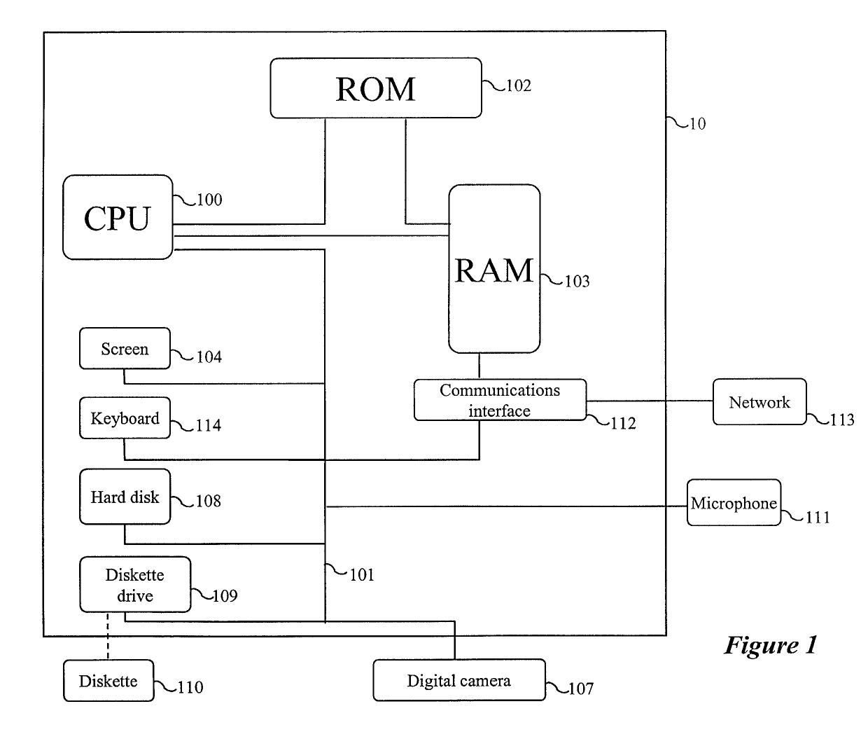

FIG. 1 is an embodiment of a device implementing the invention,

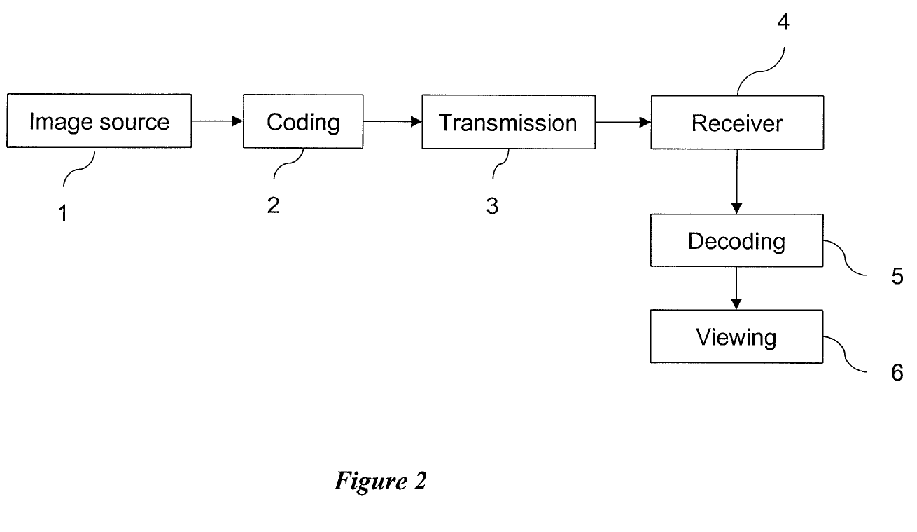

FIG. 2 represents a coding device and a decoding device according to the invention,

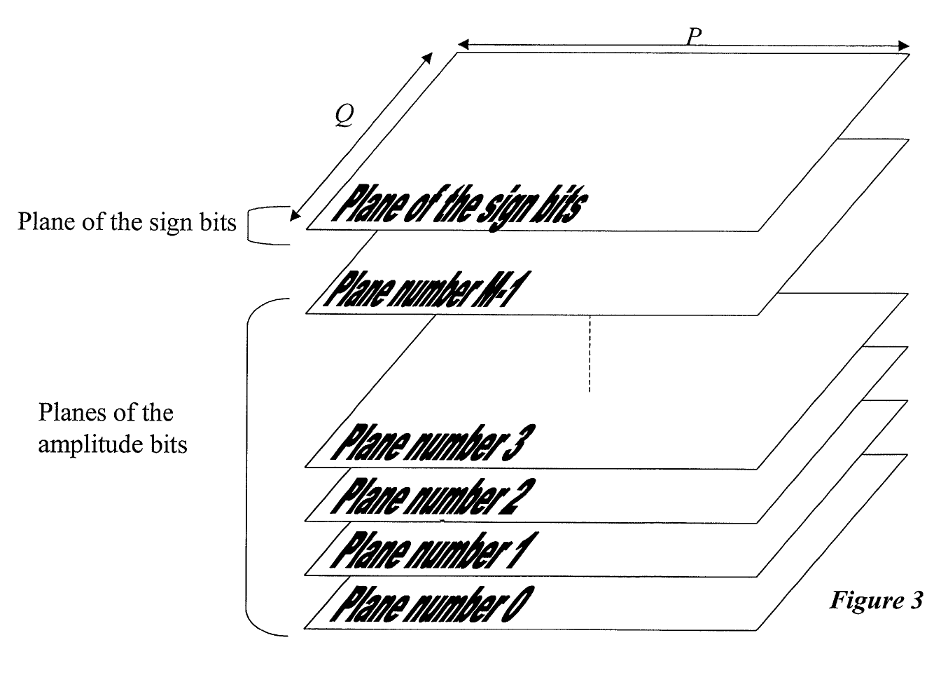

FIG. 3 represents a frequency sub-band obtained in the coding device

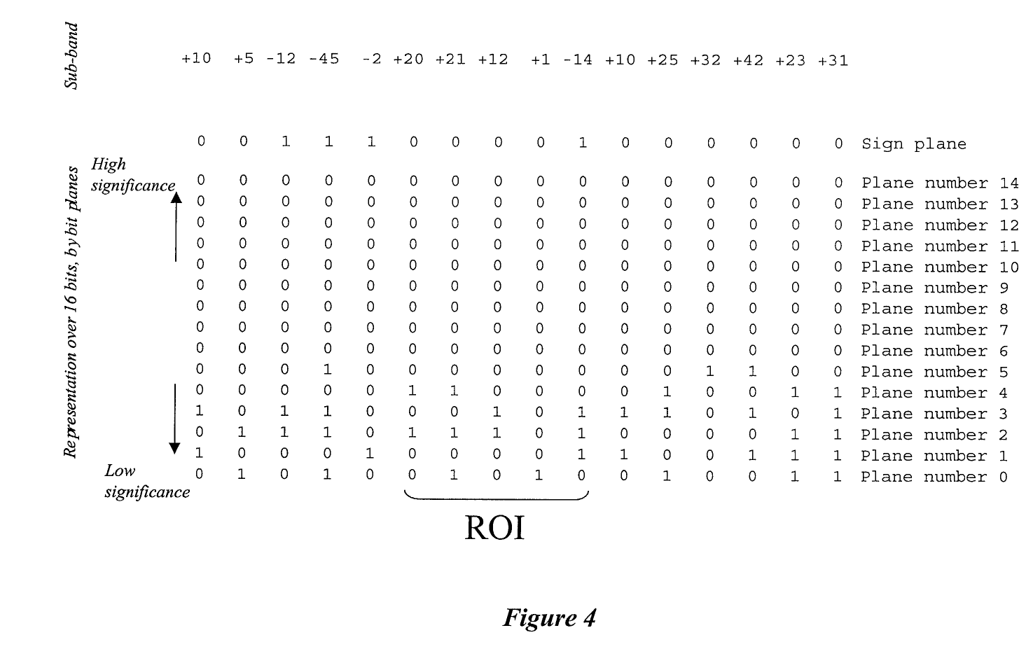

FIG. 4 is a bit plane representation of a digital signal,

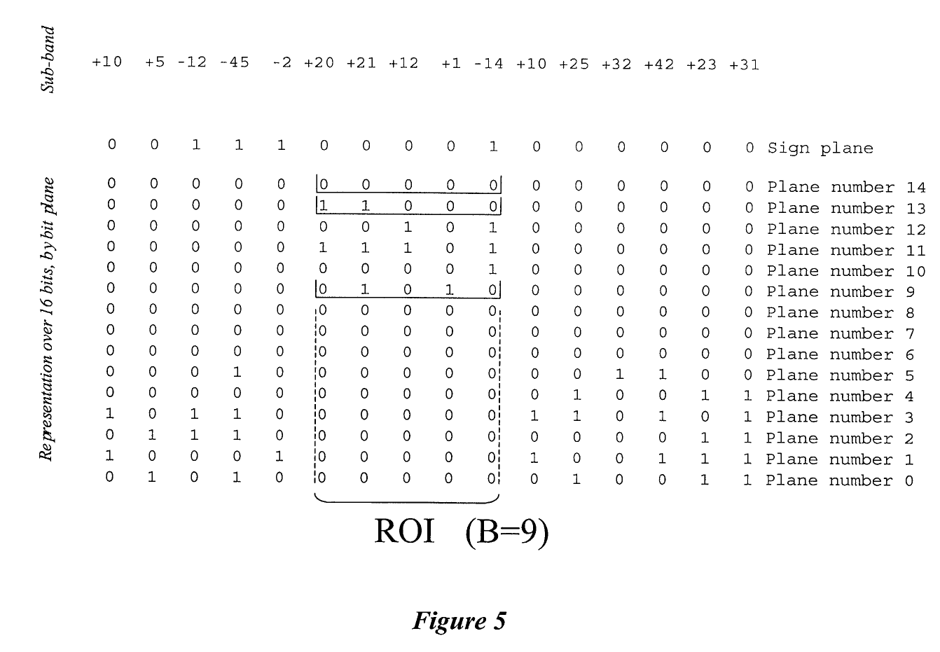

FIG. 5 is a bit plane representation of a digital signal, in which a region of interest has been boosted,

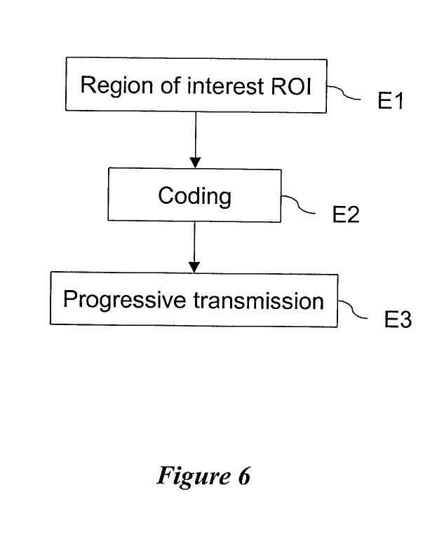

FIG. 6 represents an implementation of the coding method,

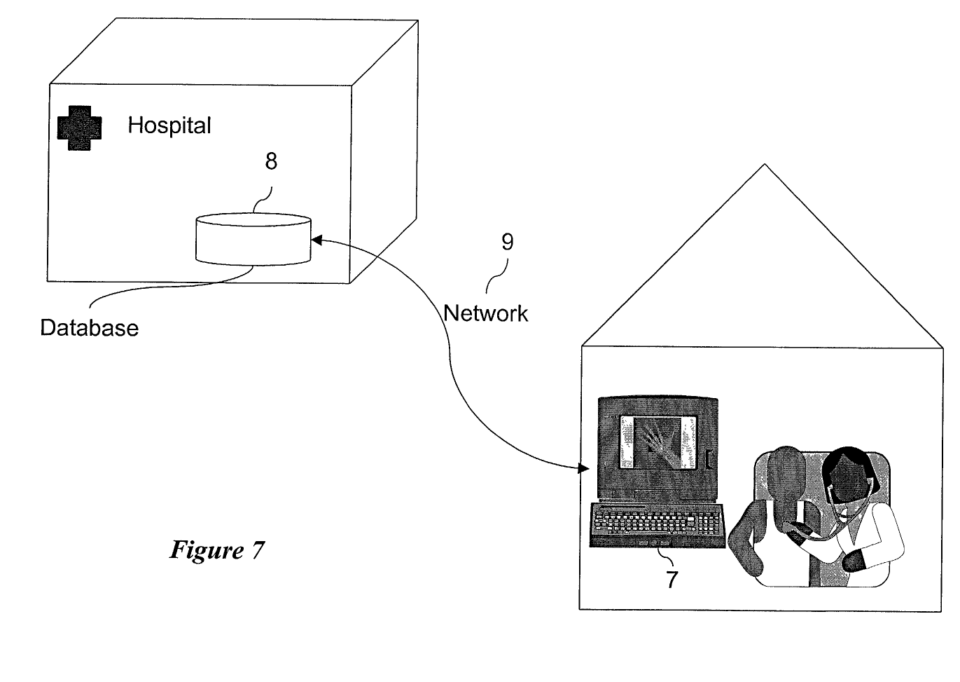

FIG. 7 represents an embodiment of a device according to the invention,

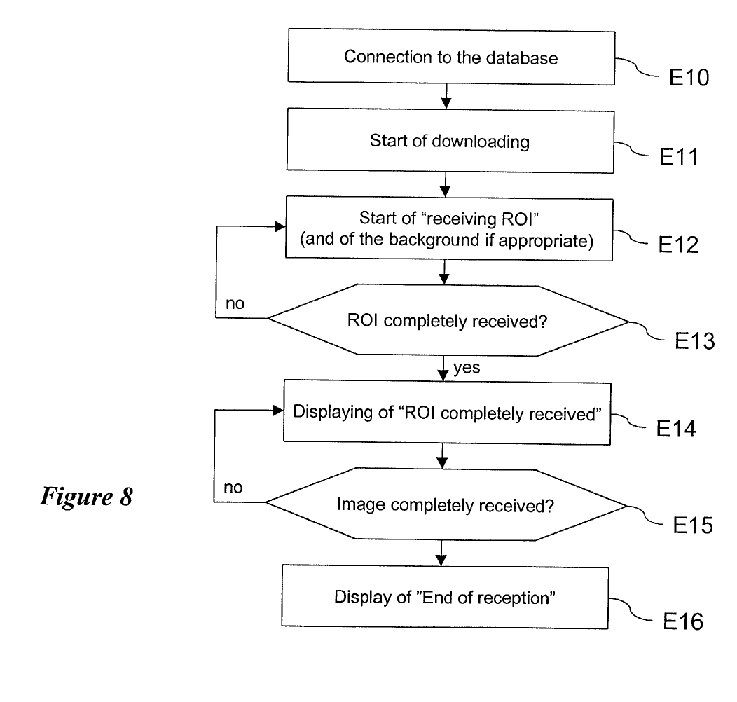

FIG. 8 represents an implementation of the decoding method according to the invention,

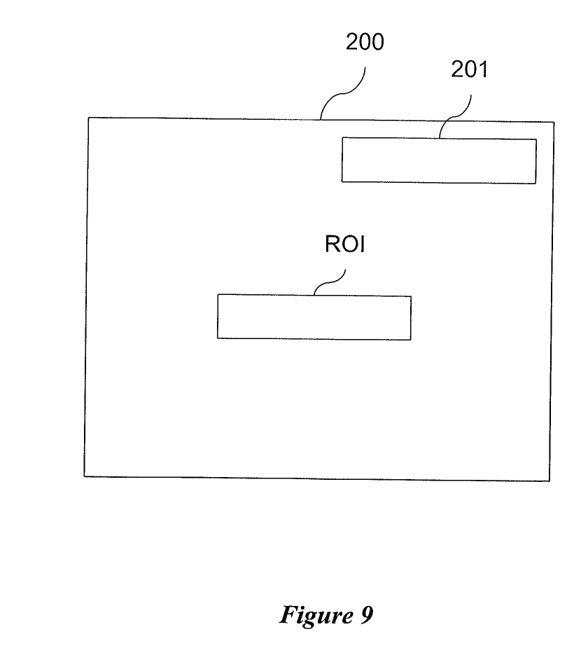

FIG. 9 represents a display area for decoded data according to the invention,

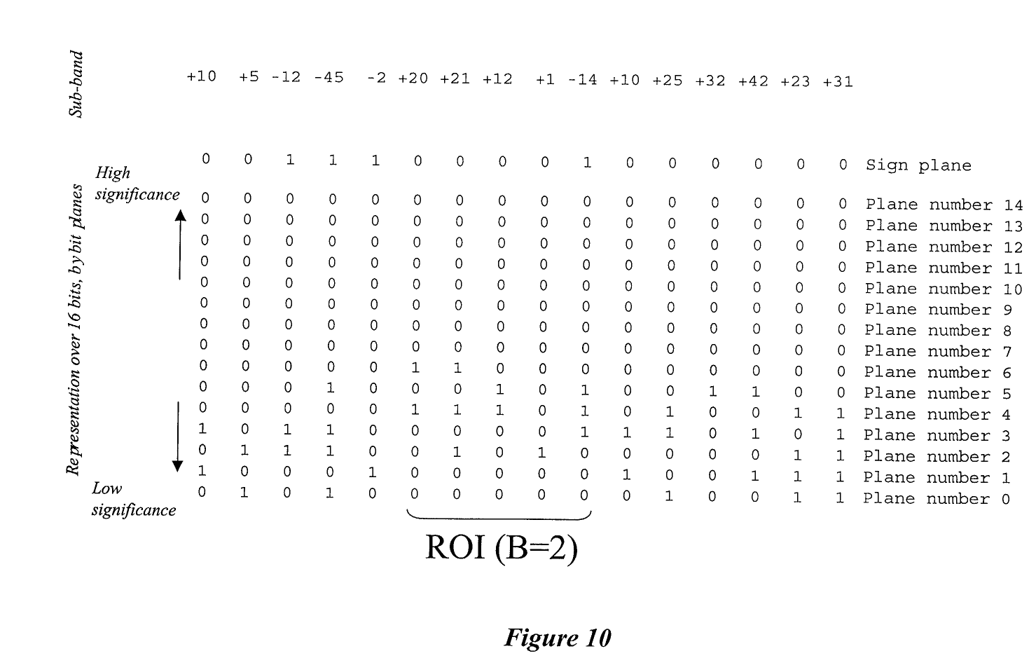

FIG. 10 is a bit plane representation of a digital signal in which a region of interest has been boosted.

According to the embodiment chosen and represented in FIG. 1, a device implementing the invention is, for example, a microcomputer 10 connected to various peripherals, for example a digital camera 107 (or a scanner, or any image acquisition or storage means) connected to a graphics card and supplying information to be processed according to the invention.

The device 10 includes a communications interface 112 linked to a network 113 able to transport digital data to be processed, or conversely data processed by the device. The device 10 also includes a storage means 108 such as a hard disk, for example. It also includes a disk 110 drive 109. This disk 110 may be a diskette, a CD-ROM or a DVD-ROM, for example. The disk 110, like the disk 108, may contain data processed according to the invention as well as the program or programs implementing the invention which, once read by the device 10, will be stored on the hard disk 108. According to one variant, the program allowing the device to implement the invention could be stored in read-only memory 102 (called ROM on the drawing). In a second variant, the program could be received so as to be stored in a way identical to that described above by means of the communications network 113.

The device 10 is linked to a microphone 111. The data to be processed according to the invention will be from the audio signal, in this case.

This same device possesses a screen 104 making it possible to view the data to be processed or to serve as interface with the user who can thus set parameters for certain processing modes, by the use of the keyboard 114 or of any other means (mouse, for example).

The central processing unit 100 (called CPU on the drawing) executes the instructions relating to the implementing of the invention, instructions stored in the read-only memory 102 or in the other storage elements. When voltage is applied, the processing programs stored in a non-volatile memory, for example the ROM 102, are transferred into the random-access memory RAM 103 which will then contain the executable code of the invention as well as registers for storing the variables necessary for implementing the invention.

More generally, an information-storage means, which can be read by a computer or by a microprocessor, incorporated into the device or otherwise, possibly removable, stores a program implementing the method of coding, of transmission and, respectively, of decoding.

The communications bus 101 allows communication between the various elements included in the microcomputer 10 or linked to it. The representation of the bus 101 is not a limitation, and the central processing unit 100 especially is capable of communicating instructions to any element of the microcomputer 10 directly or via another element of the microcomputer 10.

With reference to FIG. 2, an embodiment of a coding device and of an associated decoding device according to the invention is more particularly intended to process digital images.

A signal source 1 contains a fixed-image signal IM. In a general way, the signal source either contains the digital signal, and, for example, includes a memory, a hard disk or a CD-ROM, or converts an analogue signal into a digital signal, and is, for example, an analogue video recorder associated with an analogue-digital converter. The image source 1 generates a series of digital samples representing an image IM. The image signal IM is a series of digital words, for example of bytes. Each byte value represents one pixel of the image IM, here with 256 grey levels or in colour.

An output from the signal source 1 is linked to a data-compression circuit 2 which carries out coding of the image, known in itself. For example, the coding used is according to the standard JPEG2000 (for Joint Photographic Expert Group), which is in the course of standardisation and a description of which is available by Internet at the address http://www.jpeg.org/cd15444-1.pdf.

Coding according to the JPEG2000 standard includes a discrete-wavelet transformation, known as DWT, then quantization and entropic coding.

On completion of the wavelet transformation, the data are processed by bit plane. As represented in FIG. 3, a frequency sub-band obtained after wavelet transformation includes P×Q coefficients, where P and Q are integers. Each coefficient includes a sign bit and M amplitude bits numbered from 0 in the case of the least significant bit up the M-1 in the case of the most significant bit, where M is an integer.

The sub-band can therefore be seen as a plane containing P×Q sign bits and M planes each containing P×Q bits.

By reference again to FIG. 2, the data-coding circuit 2 is linked to a data-transmission circuit 3. The circuit 3 is conventional and is suitable for transmitting data intended for a receiving circuit 4, via a transmission network.

The circuit 4 is linked to the data-decoding circuit 5, itself linked to a circuit 6 for viewing the decoded data.

The operation of the coding device and of the decoding device will be detailed in what follows.

FIG. 4 represents an example representation, by bit planes, in a one-dimensional case. This case is, for example, a line of data extracted from a frequency sub-band of the image.

Plane number zero contains the least significant bits and the planes are sequenced in such a way as to contain bits of higher and higher significance in proportion as the numbers of the planes increase. Hence, plane number 14 contain the most significant bits.

In this example, it is observed that the most significant bit plane containing at least one bit at the value one is plane number five.

Moreover, a boost value B is defined as a function of several parameters, particularly including the type of wavelet transformation used.

The boost value is higher than or equal to the highest-numbered bit plane containing at least one non-zero bit for all the sub-bands of the signal. This bit plane is the highest bit plane reached by the signal.

For example, for an image coded over eight bits (i.e. up to plane number 7), a wavelet transformation is considered in which the filter multiplies the dynamic range of the signal by 4 (2 in vertical filtering and 2 in horizontal filtering). The highest bit plane reached after transformation is then plane number 9, since multiplication of the dynamic range by 4 requires 2 additional bits for coding.

FIG. 5 represents the same data as in FIG. 4, to which a boost value equal to 9 has been applied over a region of interest ROI. A region of interest is a part of the image to which the user accords greater importance than the rest of the image. For example, a region of interest is a face in a portrait, or the fractured part of a bone in an x-ray. It should be noted that the region of interest may be formed from several disjointed parts of the image.

The data associated with the region of interest are transferred 9 bit planes higher.

It should be noted that it is not necessary to associate information to indicate which is the region of interest, especially during the transmission of the data. This is because, in order to recover the region of interest during the decoding of the data, it is sufficient to detect the coefficients for which non-zero bits exist in the bit planes numbered higher than or equal to 9.

These data have necessarily been boosted, since the signal does not naturally reach this dynamic range.

During decoding, it is sufficient then to transfer these data nine bit planes lower in order to obtain the decoded signal.

FIG. 6 represents a method of coding an image with a region of interest. This method is employed in the coding device of FIG. 1 and includes stages E1 to E3.

The method is implemented in the form of an algorithm which can be wholly or partly stored in memory in any information-storage means capable of working with the microprocessor. This storage means can be read by a computer or by a microprocessor. This storage means is or is not integrated into the device, and may be removable. For example, it may include a magnetic tape, a diskette or a CD-ROM (compact disc with fixed memory).

Stage E1 is the definition of a region of interest in the image. To do that, a window for each part of the region of interest can be designated by using the mouse, on the image displayed on the screen. Each part of the region of interest may also be defined by entering its coordinates using the keyboard.

The following stage E2 is a coding of the image with progressive quality (or “quality scalable”). Thus, the data contained in the compressed file are organised in such a way that the most important data are at the start of the file. The most important data are understood here to be the bit planes of most significance.

The coding includes operations of boosting a region of interest, in addition to the conventional operations which are not described here.

It should be noted that the boost value B is associated with the compressed file containing the result of the coding of the image.

The following stage E3 is a progressive transmission of the data. The most important data are transmitted first. Hence, on reception, the most important data are received first, and can be processed before the rest of the data. In particular, the most important data can be decoded and displayed, in the case of an image signal, before all the data have been received.

As represented in FIG. 7, one embodiment of the implementation of the invention includes a computer 7, which can be connected to a remote database 8, via a telecommunications network 9.

The database 8 contains data coded as described above. These data are images, more particularly.

FIG. 8 represents an implementation of the alerting method which is performed during the progressive decoding of the previously coded image. This method is implemented in the form of an algorithm stored in memory of the computer 7. It is run in parallel with the receiving and with the decoding of the image, which are not described in detail here.

The method can be wholly or partly stored in memory in any information-storage means capable of working with the microprocessor of the computer. This storage means is or is not integrated into the device, and may be removable. For example, it may include a magnetic tape, a diskette or a CD-ROM (compact disc with fixed memory).

The algorithm includes stages E10 to E16.

Stage E10 is a connection from the computer 7 to the database 8, via the network 9. The connection is conventional and will not be described here.

Stage E11 is the starting of the downloading of an image which has subsequently been coded as described above. As long as no data of the image has been received, an indicator is displayed in the window for displaying the image in order to indicate that.

FIG. 9 represents the window 200 for displaying the image, with the region of interest ROI and the indicator-display area 201. The window 200 is displayed on the screen of the computer 7.

Obviously, the position of the region of interest is defined at coding. The position of the indicator-display area can be altered by the user.

When the data of the image reach the computer 7, stage E12 is a display of an indicator in the image-display window in order to indicate that the region of interest ROI is being received and decoded. This indicator indicates the start of the decoding of the region of interest, then the progress of the decoding thereof.

The bit planes are sent in decreasing number order and the data of the region of interest are contained in the bit planes with the highest numbers. As long as the number of the bit plane being sent is higher than or equal to 8, that corresponds to data to which the boost factor B has been applied, with B=9 in this example. These data are those of the region of interest.

As already specified, the boost value B is used during the decoding of the data in order to transfer the boosted data B bit planes lower.

The following stage E13 is a test to check whether the region of interest ROI has been completely received and decoded. The test is carried out on the numbers of bit planes received.

As long as the response is negative, this stage is followed by the previously described stage E12.

When the response is positive at stage E13, this stage is followed by stage E14 at which an indicator is displayed in the image-display window in order to indicate that the region of interest has been completely received and consequently that its decoding is terminated.

The data not belonging to the region of interest are then being received and decoded.

The following stage E15 is a test in order to check whether the image has been completely received and decoded.

As long as the response is negative, this stage is followed by the previously described stage E14. The indicator may, moreover, display an indication of decoding of the data not belonging to the region of interest.

When the response is positive at stage E15, this stage is followed by stage E16 at which an indicator is displayed in the image-display window in order to indicate that the image has been completely received.

Clearly, the user can interrupt reception before the entire image has been received.

In a variant, the boost factor is chosen in such a way that the region of interest is not entirely “above” the rest of the signal (FIG. 5), but is “slightly” emphasised by comparison with the rest of the signal. In this mode, known as scaling, the boost factor can take any value greater than or equal to one.

In this case, the coordinates of the region of interest are added as additional information to the file containing the image.

On reception, this additional information makes it possible to recover the region of interest.

FIG. 10 represents an example bit plane representation, in which a boost factor equal to two has been applied to the region of interest.

The decoding of the image is similar to that described above, with the difference that the detection of the region of interest is carried out by virtue of the coordinates thereof, and no longer by analysing the dynamic range of the received signal, as in the previous example.

Clearly, the present invention is not in any way limited to the embodiments described and represented, but, on the contrary, encompasses any variant within the grasp of the person skilled in the art.

1. Method for alerting during the progressive decoding of a digital image coded with a region of interest (ROI), characterised in that it includes the stages of:
detection (E13) of the end of the decoding of the said region of interest,
activation (E14) of an indication of the end of decoding of the said region of interest.

2. Method according to claim 1 characterised in that it further includes the stages of:
activation (E12) of an indication of the start of decoding of the said region of interest,
activation (E12) of an indication of the progress of the decoding of the said region of interest.

3. Method according to claim 1 or 2, characterised in that it further includes the stages of:
activation (E14) of an indication of decoding of the coded data of the image which are not in the said region of interest.
activation (E16 of an indication of the end of decoding of the coded data of the image which are not in the said region of interest.

4. Method according to any one of claims 1 to 3, characterised in that the indication is a display of information data (201) on a screen.

5. Data receiving method incorporating the alerting method according to any one of claims 1 to 4.

6. Method for progressive decoding of a digital image coded with a region of interest, incorporating the alerting method according to any one of claims 1 to 4.

7. Device for alerting during the progressive decoding of a digital image coded with a region of interest, characterised in that it includes:
means (5) for detecting the end of the decoding of the said region of interest,
means (5, 6) for activating an indication of the end of decoding of the said region of interest.

8. Device according to claim 7, characterised in that it further includes:
means for activating an indication of the start of decoding of the said region of interest,
means for activating an indication of the progress of the decoding of the said region of interest.

9. Device according to claim 7 or 8, characterised in that it further includes:
means for activating an indication of the decoding of the coded data of the image which are not in the said region of interest,
means for activating an indication of the end of decoding of the coded data of the image which are not in the said region of interest.

10. Device according to any one of claims 7 to 9, characterised in that it includes means (6) for displaying information data on a screen.

11. Data receiving device incorporating the alerting device according to any one of claims 7 to 10.

12. Device for progressive decoding of a digital image coded with a region of interest, incorporating the alerting device according to any one of claims 7 to 10.

13. Device according to any one of claims 7 to 12, characterised in that the detection and activation means are incorporated into:
a microprocessor (100),
a read-only memory (102) including a program for processing the data, and
a random-access memory (103) including registers suitable for registering variables modified in the course of the running of the said program.

14. Apparatus (10) for processing a digital image, characterised in that it includes means suitable for implementing the method according to any one of claims 1 to 6.

15. Apparatus (10) for processing a digital image, characterised in that it includes the device according to any one of claims 7 to 13.

16. Storage medium storing a program for alerting during the progressive decoding of a digital image coded with a region of interest according to any one of claims 1 to 3.

17. Storage medium according to claim 16, characterized in that it is detachably mountable on a device according to any one of claims 7 to 12.

18. Storage medium according to claim 16, characterized in that it is a floppy disk or a CD-ROM.

19. Computer program on a storage medium and comprising computer executable instructions for causing a computer to alert during the progressive decoding of a digital image coded with a region of interest according to any one of claims 1 to 3.
